(19) United States
(12) Patent Application Publication
(10) Pub. No.: US 2004/0259019 A1
(43) Pub. Date: Dec. 23, 2004

(54) Positive photosensitive composition

(75) Inventor: Isao Yahagi, Ibaraki (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/765,843

(22) Filed: Jan. 29, 2004

(30) Foreign Application Priority Data
Feb. 24, 2003 (JP) 2003-045527

(51) Int. Cl. G03C 1/52

(52) U.S. Cl. 430/154

(57) ABSTRACT

A positive photosensitive composition comprising a quinonediazide compound, a novolak resin, a compound reacting with the novolak resin by the action of an acid, and a compound generating an acid by heating.

### BACKGROUND OF THE INVENTION

1. Field of the Invention

The present invention relates to a positive photosensitive composition.

2. Description of Related Art

Semiconductor devices mounted on portable telephones, mobile instruments and the like are required to have high speed performance, multiple functions and small size. Therefore, wafer level package effecting packaging of a chip in wafer condition is under investigation.

In wafer level package, using a solder bump formed on a rewiring layer made of copper, aluminum and the like, a chip is connected to a wafer in the order of the chip, solder bump, rewiring layer and wafer, and for securing the reliability of the device, an insulation layer is formed between the rewiring layer and the wafer.

As the insulation layer, there is known an insulation layer obtained by thermal-hardening of a positive photosensitive composition containing a novolak resin and a diazonaphthoquinone compound (see, JP-A No. 2000-138219). However, there is a problem that the pattern tends to deform in thermal-hardening for pattern formation.

### SUMMARY OF THE INVENTION

The present invention provides a positive photosensitive composition giving a pattern showing little deformation in forming the pattern by thermal-hardening.

The present inventors have intensively studied to find a positive photosensitive composition capable of solving the problem as described above, and resultantly found that a positive photosensitive composition comprising a quinonediazide compound, a novolak resin, a compound reacting with the novolak resin by the action of an acid, and a compound generating an acid by heating, can be produced a pattern showing little deformation in forming the pattern by thermal-hardening.

Namely, the present invention provides the following [1] to [5].

[1] A positive photosensitive composition comprising a quinonediazide compound, a novolak resin, a compound reacting with the novolak resin by the action of an acid, and a compound generating an acid by heating.

[2] The positive photosensitive composition according to [1], wherein the compound generating an acid by heating is a compound which is decomposed at 80 to 200° C. to generate an acid.

[3] The positive photosensitive composition according to [1] or [2], wherein the compound reacting with the novolak resin by the action of an acid is at least one selected from the group consisting of compounds of the following formula (1) and compounds of the following formula (2).

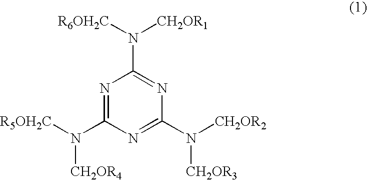

(wherein, R₁ to R₆ each independently represent a mono-valent organic group having 1 to 20 carbon atoms.).

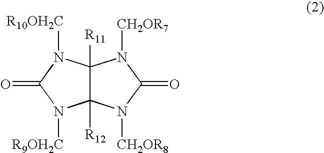

(wherein, R₇ to R₁₀ each independently represent a mono-valent organic group having 1 to 20 carbon atoms, R₁₁, R₁₂ each independently represent a hydrogen atom or a mono-valent organic group having 1 to 20 carbon atoms.).

[4] A process for producing a pattern, wherein the process comprises the steps of applying the positive photosensitive composition according to any of [1] to [3] on a substrate, exposing the applied composition, developing the exposed portion, and hardening un-exposed portions by heating.

[5] The process according to [4], wherein the pattern is a member of semiconductor or a member of display.

### DETAILED DESCRIPTION OF THE INVENTION

The present invention will be illustrated further in detail below.

The positive photosensitive composition of the present invention comprises a quinonediazide compound, a novolak resin, a compound reacting with the novolak resin by the action of an acid, and a compound generating an acid by heat.

As the quinonediazide compound and novolak resin, a positive photoresist composition containing a quinonediazide compound and a novolak resin can be used. The positive photoresist composition can also contain a surfactant and the like in addition to the quinonediazide compound and novolak resin.

As the quinonediazide compound, there are listed, for example, ester compounds having a 1,2-naphthoquinonediazide group such as 1,2-naphthoquinonediazide-4-sulfonates, 1,2-naphthoquinonediazide-5-sulfonates and the like.

The above-mentioned ester compound can be produced by known methods in which, for example, a naphthoquinonediazide sulfonic halide such as naphthoquinonediazide sulfonic chloride and the like and a compound having a phenolic hydroxyl group are condensed in the presence of a weak alkali (condensation reaction).

As the above-mentioned compound having a phenolic hydroxyl group, there are listed, for example, 4-(1′,2′,3′,4′,4′a,9′a-hexahydro-6′-hydroxy-5′-methylspiro[cyclohexane-1,9′-xanthene]-4′a-yl)-2-methylresorcinol, 2,3,4,4′-tetrahydroxybenzophenone, 4,4′-methylenebis[2-(2-hydroxy-5-methylbenzyl)-3,6-dime thylphenol and the like (see, Japanese Patent Application Laid-Open (JP-A) No. 10-232493).

The content of a quinonediazide compound in the positive photosensitive composition is preferably from 1 to 30 wt %, more preferably from 3 to 10 wt %. When the content is 1 to 30 wt %, dissolution contrast is preferably large.

As the novolak resin, there are listed, for example, phenol novolak resins, cresol novolak resins such as metacresol novolak resin, orthocresol paracresol copolymerized novolak resin and the like.

The content of a novolak resin in the positive photosensitive composition is preferably from 5 to 50 wt %, more preferably from 10 to 30 wt %. When the content is 5 to 50 wt %, resolution is preferably high.

As the compound reacting with the novolak resin by the action of an acid, there are listed, for example, melamine derivatives, urea derivatives, mixtures thereof, and the like. Among them, at least one compound selected from the group consisting of compounds of the following formula (1) and compounds of the following formula (2) is preferable.

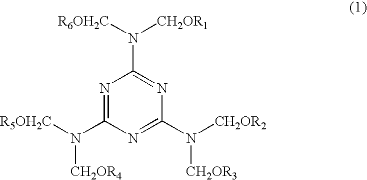

(wherein, R₁ to R₆ each independently represent a mono-valent organic group having 1 to 20 carbon atoms.).

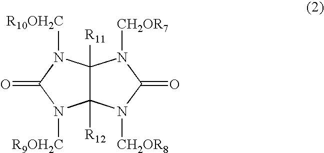

(wherein, R₇ to R₁₀ each independently represent a mono-valent organic group having 1 to 20 carbon atoms, R₁₁, R₁₂ each independently represent a hydrogen atom or a mono-valent organic group having 1 to 20 carbon atoms.).

As the mono-valent organic group having 1 to 20 carbon atoms, linear, branched and cyclic organic group can be used, and there are listed, for example, linear aliphatic hydrocarbon groups having 1 to 20 carbon atoms, branched aliphatic hydrocarbon groups having 3 to 20 carbon atoms, cyclic aliphatic hydrocarbon groups having 3 to 20 carbon atoms, and aromatic hydrocarbon groups having 6 to 20 carbon atoms optionally substituted with an alkyl group and the like, and linear hydrocarbon groups having 1 to 6 carbon atoms, branched hydrocarbon groups having 3 to 6 carbon atoms and cyclic hydrocarbon groups having 3 to 6 carbon atoms are preferable.

As the linear aliphatic hydrocarbon groups having 1 to 20 carbon atoms, for example, a methyl group, ethyl group, propyl group, butyl group, pentyl group, hexyl group and the like are listed.

As the branched aliphatic hydrocarbon groups having 3 to 20 carbon atoms, for example, an isopropyl group, isobutyl group, tertiary butyl group and the like are listed.

As the cyclic aliphatic hydrocarbon groups having 3 to 20 carbon atoms, for example, a cyclopropyl group, cyclobutyl group, cyclopentyl group, cyclohexyl group and the like are listed.

As the aromatic hydrocarbon group having 6 to 20 carbon atoms optionally substituted with an alkyl group and the like, for example, a phenyl group, naphthyl group, anthryl group, tolyl group, xylyl group, dimethylphenyl group, trimethylphenyl group, ethylphenyl group, diethylphenyl group, triethylphenyl group, propylphenyl group, butylphenyl group, methylnaphthyl group, dimethylnaphthyl group, trimethylnaphthyl group, ethenylnaphthyl group, methylanthryl group, ethylanthryl group and the like are listed.

As the compound of the formula (1), there are listed, for example, hexakis(methoxymethyl)melamine, hexakis(ethoxymethyl)melamine and the like.

As the compound of the formula (2), there are listed, for example, 1,3,4,6-tetrakis(methoxymethyl)glycolurea, 1,3,4,6-tetrakis(ethoxymethyl)glycolurea, 1,3,4,6-tetrakis(butoxymethyl)glycolurea and the like.

The compound of the formula (1) can be produced and obtained easily, for example, by a method in which melamine is reacted with formalin under an alkaline condition for methylolation, the obtained methylolmelamine is alkylated with an alcohol compound such as methanol and the like under an acidic condition.

The compound of the formula (2) can be produced and obtained easily, for example, by a method in which glycolurea is reacted with formalin under an alkaline condition for methylolation, the obtained methylolglycourea is alkylated with an alcohol compound such as methanol and the like under an acidic condition.

As the compound reacting with the novolak resin by the action of an acid, alkoxymethyl-substituted aromatic compounds, acetoxymethyl-substituted aromatic compounds, methylol-substituted aromatic compounds and the like can also be used in addition to the above-mentioned compounds.

As the alkoxymethyl-substituted aromatic compound, there are listed 1,4-dimethoxymethylbenzene, 1,2-dimethoxymethylbenzene, 1,3-dimethoxymethylbenzene, 1,3,5-trimethoxymethylbenzene, 1,4-dibutoxymethylbenzene, 1,2-dibutoxymethylbenzene, 1,3-dibutoxymethylbenzene, 1,3,5-tributoxymethylbenzene and the like.

As the acetoxymethyl-substituted aromatic compound, there are listed 1,4-diacetoxymethylbenzene, 1,2-diacetoxymethylbenzene, 1,3-diacetoxymethylbenzene, 1,3,5-triacetoxymethylbenzene and the like.

As the methylol-substituted aromatic compound, there are listed 1,4-dimethylolbenzene, 1,2-dimethylolbenzene, 1,3-dimethylolbenzene, 1,3,5-trimethylolbenzene and the like.

The content of the compound reacting with the novolak resin by the action of an acid is preferably from 0.1 to 50 wt %, more preferably from 0.5 to 30 wt % based on the total amount of a quinonediazide compound and a novolak resin. When the content is from 0.1 to 50 wt %, resolution is preferably excellent.

As the compound generating an acid by heating, compounds decomposed at 80° C. to 200° C. to generate an acid are preferable, compounds decomposed at 100° C. to 180° C. to generate an acid are more preferable, and compounds decomposed at 100° C. to 150° C. to generate an acid are further preferable.

As the compound generating an acid by heating, there are listed, for example, sulfonate of (2-carbonylphenyl-2-hydroxy-2-phenyl)ethanol, triphenylsulfonium salts of camphorsulfonic acid, toluenesulfonic acid and trifluoromethanesulfonic acid, naphthyldimethylsulfonium salts of camphorsulfonic acid, toluenesulfonic acid and trifluoromethanesulfonic acid, diphenyliodonium salts of camphorsulfonic acid, toluenesulfonic acid and trifluoromethanesulfonic acid, bis(phenylsulfonyl)diazomethane, and the like.

Specifically listed are MBZ-101, DPI-105, DPI-106, DPI-109, DPI-201, BI-105, MPI-103, MPI-105, MPI-106, MPI-109, BBI-106, BBI-109, BBI-110, TPS-105, TPS-109, MDS-105, MDS-205, BDS-109, NDS-105, NDS-155, NDS-159, DAM-101, DAM-102, DAM-103, DMA-105, DAM-201, DAM-301, DMA-401, MBZ-201, MBZ-301, DNB-101 and the like, manufactured by Midori Kagaku Co., Ltd.

The content of the compound generating an acid by heating in the positive photosensitive composition is preferably from 0.1 to 10 wt %, more preferably from 0.1 to 5 wt %. When the content is from 0.1 to 10 wt %, a pattern manifesting little heat reflow is preferably obtained.

The positive photosensitive composition may contain a surfactant and the like, if necessary.

As the surfactant, there are listed, for example, nonionic surfactants such as fluorinated alkyl esters, perfluoroalkylethylene oxides and the like.

A process for producing a member for semiconductor or a member for display using a positive photosensitive composition of the present invention will be explained using one example thereof.

First, a positive photosensitive composition of the present invention is applied partially or on the whole surface of a substrate. As the application method, there are listed, for example, bar coater, roll coater, die coater, spin coater and the like.

After application, the composition is, if necessary, dried at 40 to 120° C. to form a membrane. A part of the formed membrane is covered with a chromium mask and the like, then, exposed using an exposure apparatus. As the exposure apparatus, there are listed, for example, a proximity exposure machine and the like.

In the case of large area exposure, a photosensitive composition is applied on a substrate, then, exposed while shifting. Thus, large area can be exposed with an exposure machine with small exposure area. As the beam used for exposure, there are listed, for example, ultraviolet rays such as i line, g line, h line, and the like

After exposure, development is conducted utilizing a difference in the degree of dissolution of an exposed portion and un-exposed portion in a developing solution. The exposed portion is removed by dissolution into a developing solution. Development is usually conducted by an immersion method, spray method, brush method and the like.

As the developing solution used, an organic alkali aqueous solution is exemplified.

As the organic alkali aqueous solution, there are listed, for example, tetramethylammonium hydroxide, monoethanolamine, diethanolamine and the like.

The concentration of the organic alkali aqueous solution is usually from 0.05 to 5 wt %, preferably from 0.1 to 3 wt %. When the concentration is from 0.05 to 5 wt %, a developing property is preferably excellent.

It is preferable from the standpoint of process management that the developing temperature is usually from 15 to 50° C.

A pattern formed by development is usually calcinated on a hot plate or oven, and the like. As the calcination atmosphere, atmospheres such as in air, nitrogen and the like are listed, and the calcination temperature is usually from about 100° C. to 300° C.

Thus, by forming a hardened material of a positive photosensitive composition on an un-exposed portion, a pattern for a member of semiconductor such as an insulation layer, an insulation membrane and the like in a rewiring process in chip scale packaging, or a member of display such as a spacer and the like for securing a space into which a liquid crystal compound is injected in a liquid crystal panel can be produced.

This pattern has an excellent performance manifesting little reflow in thermal hardening. Here, little reflow in thermal hardening means that the change in pattern dimension between before thermally hardened at 200° C. and after thermally hardened at 200° C. is within 10%.

The present invention can provide a positive photosensitive composition giving an insulation membrane manifesting little deformation of a pattern in forming a pattern by thermal-hardening.

### EXAMPLES

The present invention will be illustrated in more detail with Examples, which should not construed as a limitation of the scope of the invention.

### Example 1

Into 5 g of Sumiresist solution for i line (2-heptanone solution) (manufactured by Sumitomo Chemical Co., Ltd.) containing a m-cresol novolak resin and a condensate of 4,4′-methylenebis[3,6-dimethyl-2-(2-hydroxy-5-methylbenzyl)phenol] and 1,2-naphthoquinonediazide-5-sulfonic chloride, was added 0.75 g of 29.4% propylene glycol 1-monomethyl ether-2-acetate solution of hexakismethoxymethylmelamine and 0.025 g of MBZ-101 (manufactured by Midori Kagaku Co., Ltd.), to prepare a uniform solution.

The resulted resist solution was applied on a silicon wafer using a spin coater, and baked on a hot plate of 80° C., to prepare a membrane of 4 μm.

Using a gradation mask (manufactured by OPTO-LINE Associates Inc.), the membrane was exposed using a proximity exposure machine (manufactured by Dainippon Screen Mfg Co., Ltd., MAP-1300). The irradiation exposure was 100 mJ/cm². After exposure, the membrane was developed with 2.38% tetramethylammonium hydroxide aqueous solution, to obtain a slit pattern of 18 μm. The width of the mask in this operation was 6 μm.

By calcination at 130° C. for 10 minutes, 150° C. for 10 minutes and 200° C. for 10 minutes on a hot plate, a slit pattern of 18 μm was obtained without deformation.

### Example 2

Into 10 g of Sumiresist solution for i line (2-heptanone solution) (manufactured by Sumitomo Chemical Co., Ltd.) containing a m-cresol novolak resin and a condensate of 4,4′-methylenebis[3,6-dimethyl-2-(2-hydroxy-5-methylbenzyl)phenol] and 1,2-naphthoquinonediazide-5-sulfonic chloride, was added 0.44 g of tetrakis(methoxymethyl)glycolurea and 0.05 g of MBZ-101 (manufactured by Midori Kagaku Co., Ltd.), to prepare a uniform solution.

The resulted resist solution was applied on a silicon wafer using a spin coater, and baked on a hot plate of 90° C., to prepare a membrane of 4 μm.

Using a Cr mask, the membrane was exposed using a reduction projection exposure apparatus (manufactured by Nikon Corp., NSR-1755i7A). The irradiation exposure was 85 mJ/cm². After exposure, post exposure bake was conducted at 110° C. for 60 seconds, and developed with 2.38% tetramethylammonium hydroxide aqueous solution, to obtain a slit pattern of 10 μm, with a mask width of 10 μm.

By calcination at 130° C. for 10 minutes, 150° C. for 10 minutes and 200° C. for 10 minutes on a hot plate, a slit pattern of 10 μm was obtained without deformation.

What is claimed is:

1. A positive photosensitive composition comprising a quinonediazide compound, a novolak resin, a compound reacting with the novolak resin by the action of an acid, and a compound generating an acid by heating.

2. The positive photosensitive composition according to claim 1, wherein the compound generating an acid by heating is a compound which is decomposed at 80 to 200° C. to generate an acid.

3. The positive photosensitive composition according to claim 1, wherein the compound reacting with the novolak resin by the action of an acid is at least one selected from the group consisting of compounds of the following formula (1) and compounds of the following formula (2). 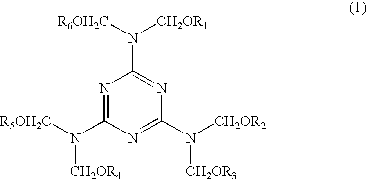
(wherein, R₁ to R₆ each independently represent a mono-valent organic group having 1 to 20 carbon atoms.). 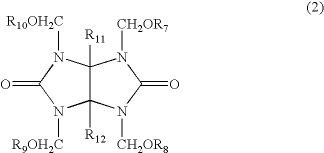
(wherein, R₇ to R₁₀ each independently represent a mono-valent organic group having 1 to 20 carbon atoms, R₁₁, R₁₂ each independently represent a hydrogen atom or a mono-valent organic group having 1 to 20 carbon atoms.).

4. A process for producing a pattern, wherein the process comprises the steps of applying the positive photosensitive composition according to claim 1 on a substrate, exposing the applied composition, developing the exposed portion, and hardening un-exposed portions by heating.

5. The process according to claim 4, wherein the pattern is a member of semiconductor or a member of display.
